(19) United States
(12) Patent Application Publication
(10) Pub. No.: US 2022/0184715 A1
(43) Pub. Date: Jun. 16, 2022

(54) DRILLING AND COUNTERSINKING TOOL AND DRILLING AND COUNTERSINKING AUXILIARY TOOL

(71) Applicant: MITSUBISHI HEAVY INDUSTRIES, LTD., Tokyo (JP)

(72) Inventors: Hirokazu Sakamoto, Tokyo (JP); Takuya Miwa, Aichi (JP)

(73) Assignee: MITSUBISHI HEAVY INDUSTRIES, LTD., Tokyo (JP)

(21) Appl. No.: 17/548,143

(22) Filed: Dec. 10, 2021

(30) Foreign Application Priority Data
Dec. 16, 2020 (JP) 2020-208156

(51) Int. Cl. B23B 51/10

(52) U.S. Cl. CPC B23B 51/10

(57) ABSTRACT

There are provided a tool and an auxiliary tool that can perform drilling and countersinking at a time to improve working efficiency while securing not only machining accuracy of the drilling but also machining accuracy of the countersinking, by using a tool including drills usable for both of the drilling and the countersinking. A tool including drills usable for drilling and countersinking, includes: a head configured to guide the drills and to hold a workpiece; a linear motion mechanism configured to relatively move the head relative to the drills with a predetermined stroke along with progress of machining by the drills; and a stopper configured to regulate displacement of the head guiding the drills in the machining by abutting on a reception portion at a terminal end of the stroke.

### BACKGROUND OF THE INVENTION

### Field of the Invention

The present disclosure relates to a tool and an auxiliary tool used for drilling and countersinking in, for example, a workpiece to which a nut plate is attached.

### Description of the Related Art

A tool is used for machining of paired holes in a workpiece to which nut plates are attached (for example, JP H5-169306 A and U.S. Pat. No. 6,200,075 B2). The tool disclosed in each of JP H5-169306 A and U.S. Pat. No. 6,200,075 B2 includes a machining mechanism including an air motor as a driving source and paired drills, and a clamping mechanism positioning the paired drills to a workpiece.

A head at a front end of the clamping mechanism includes a collet element corresponding to a hole already bored in the workpiece, and guide holes guiding the paired drills in machining. When the head is driven rearward (toward base end side of drills) by an air cylinder provided in the clamping mechanism, the workpiece is held at the head by the collet element.

Further, when the head holding the workpiece is retreated by the air cylinder while the paired drills are rotationally driven around respective axes, the drilling is performed by the paired drills advancing toward the workpiece at the same time, and countersinking of the holes is performed following the drilling. Nut plates are attached to the workpiece by using rivets and the like inserted into the holes.

In a case where machining accuracy of the countersinking does not satisfy required accuracy due to large variation of depths of countersinks machined by a tool for a nut plate, drilling is performed by the tool and countersinking is then performed by using another tool (for example, micro stop countersink). This makes it possible to secure machining accuracy of the countersinking. However, the drilling step and the countersinking step are divided. This causes wasted working hours.

In particular, in a field of an aircraft, machining accuracy required for the countersinking is high in terms of reduction of air resistance and the like.

An object of the present disclosure is to provide a tool and an auxiliary tool that can perform drilling and countersinking at a time to improve working efficiency while securing not only machining accuracy of the drilling but also machining accuracy of the countersinking, by using a tool including drills usable for both of the drilling and the countersinking.

### SUMMARY OF THE INVENTION

A backlash necessary for machining is set to a movable portion of the tool. The inventors of the present disclosure carried out research for variation causes of depths and the like of countersinks machined by the tool for the nut plate. As a result, it was confirmed that the head is inclined due to a backlash (fitting tolerance) of a piston with respect to a cylinder of the clamping mechanism, which increases the depths of the countersinks more than set values.

This is described with reference to an example illustrated in FIG. 10A and FIG. 10B. A piston rod 91 of a clamping cylinder is coupled to a head 92. In machining, drills 93 are guided by drill bushes provided in the head 92, in an axial direction of each of the drill bushes.

When the head 92 is inclined as illustrated by alternate long and short dash lines due to backlash of the piston rod 91, the inclination influences on positions of the drills 93 guided by the head 92. When the head 92 is inclined by a displacement amount corresponding to a length of the piston rod 91, for example, the positions of the drills 93 are varied within a range up to a dimension y1 in a vertical direction of the tool as illustrated in FIG. 10A, and are varied within a range up to a dimension x1 in a lateral direction of the tool as illustrated in FIG. 10B.

When the positions of the drills 93 are deviated from prescribed positions in the countersinking, depths and angles of the countersinks are varied.

Through the research of variation causes of the countersink depth, the inventors of the present disclosure have conceived an idea that the positions of the drills in the countersinking are fixed while the backlash of the tool is remained by an amount necessary for machining but a backlash near a terminal end of a stroke is suppressed as much as possible.

A drilling and countersinking tool according to the present disclosure accomplished in view of the above-described idea is a tool including drills usable for drilling and countersinking, and the tool includes: a head configured to guide the drills and to hold a workpiece; a linear motion mechanism configured to relatively move the head relative to the drills with a predetermined stroke along with progress of machining by the drills; and a stopper configured to regulate displacement of the head guiding the drills in the machining by abutting on a reception portion at a terminal end of the stroke.

Further, a drilling and countersinking auxiliary tool according to the present disclosure is an auxiliary tool attachable to a drilling and countersinking tool that includes a head and a linear motion mechanism. The head is configured to guide drills usable for drilling and countersinking and to hold a workpiece, and the linear motion mechanism is configured to relatively move the head relative to the drills with a predetermined stroke along with progress of machining by the drills. The auxiliary tool corresponds to a stopper configured to regulate displacement of the head guiding the drills in the machining by abutting on a reception portion at a terminal end of the stroke.

According to the present disclosure, since the stopper abuts on the reception portion at the stroke terminal end, the number of supporting points of the head is increased and the backlash of the tool is restricted at the end of the drilling and the countersinking. Therefore, inclination of the head is restricted. As a result, the positions of the drills that are guided by the head and countersink the workpiece can be fixed at the end of machining. This makes it possible to suppress variation of the depths and the angles of the countersinks, and to secure machining accuracy required for the countersinking.

Since the machining accuracy of the countersinking is secured by the tool according to the present disclosure in addition to the machining accuracy of the drilling, it is possible to machine the countersinks at a time only by using the tool according to the present disclosure without changing the tool to another countersinking tool. This makes it possible to shorten the time necessary for the drilling and the countersinking and to improve productivity.

### BRIEF DESCRIPTION OF THE DRAWINGS

FIG. 1 is a side view illustrating a drilling and countersinking tool according to a first embodiment;

FIG. 2 is a top view illustrating a state where a head of the tool in FIG. 1 is driven from a standby position to a terminal end of a stroke;

FIG. 3A is a plan view illustrating a workpiece to be drilled and countersunk by the tool in FIG. 1;

FIG. 3B is a perspective view illustrating a state where a plurality of nut plates are attached to the workpiece in FIG. 3A with rivets;

FIG. 4 is a perspective view illustrating a head and a stopper provided in the tool in FIG. 1;

FIG. 5 is a diagram illustrating two holding assemblies to be assembled to the head in FIG. 4 and a locking portion, the two holding assemblies being different in diameter of a mandrel from each other;

FIGS. 6A-6D are exploded side views of one of the holding assemblies illustrated in FIG. 5;

FIG. 7A is a top view illustrating a drilling and countersinking tool according to a second embodiment;

FIG. 7B is a perspective view illustrating an auxiliary tool attached to the tool in FIG. 7A;

FIG. 8A is a top view illustrating a drilling and countersinking tool according to a third embodiment;

FIG. 8B is a perspective view schematically illustrating an auxiliary tool attached to the tool in FIG. 8A;

FIG. 9 is a top view schematically illustrating a drilling and countersinking tool and an auxiliary tool attached to the tool according to a fourth embodiment;

FIG. 10A is a diagram illustrating displacement amounts of a head and drills by backlash in a vertical direction of an existing tool; and

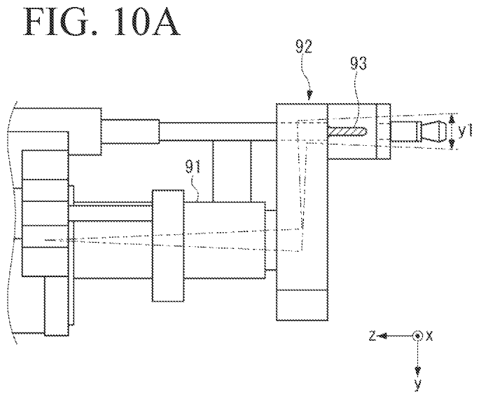

FIG. 10B is a diagram illustrating displacement amounts of the head and the drills by backlash in a horizontal direction of the existing tool.

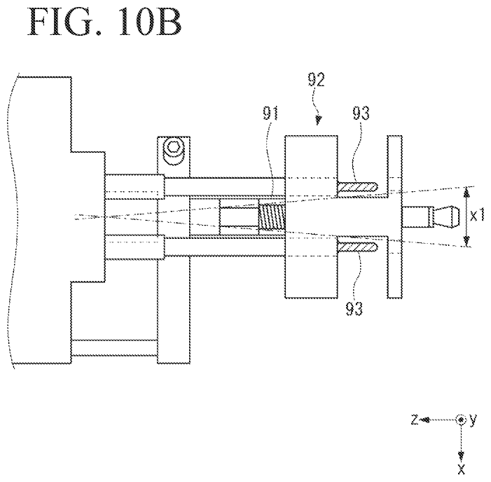

### DETAILED DESCRIPTION OF THE PREFERRED EMBODIMENTS

Some embodiments are described below with reference to accompanying drawings.

### First Embodiment

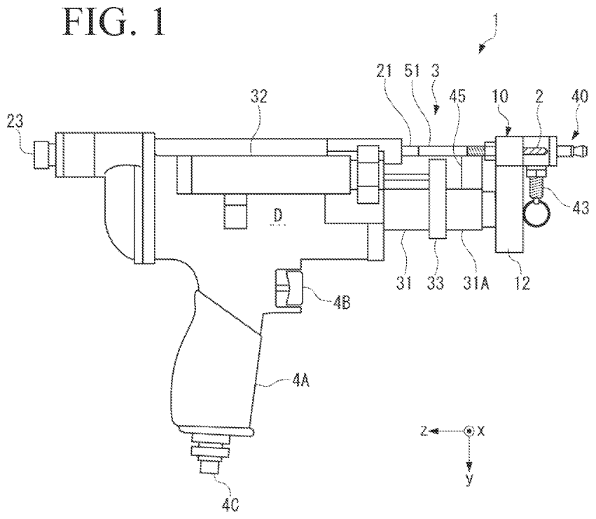

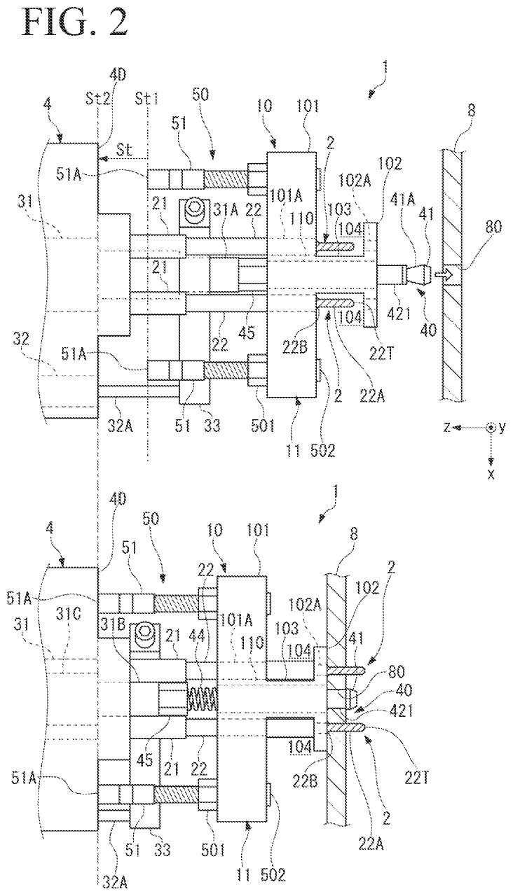

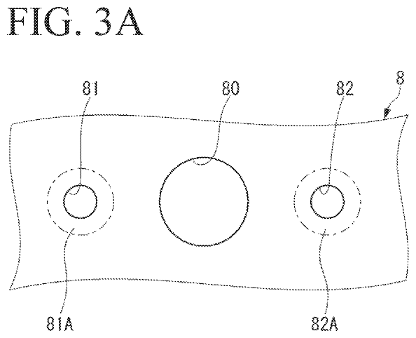

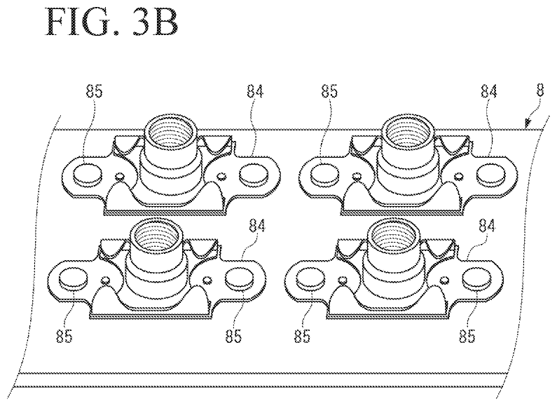

A drilling and countersinking tool 1 illustrated in FIG. 1 and FIG. 2 includes drills 2, a driving mechanism D rotationally driving the drills 2, a feeding mechanism 3 relatively moving the drills 2 and a workpiece 8 (FIG. 3A), and a housing 4.

The housing 4 includes a grip portion 4A, a trigger 4B, and a supply portion 4C connected to a compressed-air supply source through an unillustrated hose or the like.

The drilling and countersinking tool 1 (hereinafter, tool 1) can perform drilling and countersinking of two holes 81 and 82 on, for example, a plate-like workpiece 8 illustrated in FIG. 3A at a time because machining accuracies of the drilling and the countersinking are secured. The drilling and countersinking of the holes 81 and 82 are performed while the workpiece 8 and the drills 2 are positioned by using a holding hole 80 already formed at an intermediate position between positions where the holes 81 and 82 are to be machined, on the workpiece 8.

For example, as illustrated in FIG. 3B, nut plates 84 are attached to the workpiece 8 with rivets 85. The rivets 85 are inserted into the holes 81 and 82 machined by the tool 1. It is required that not only accuracies of the positions and diameters of the holes 81 and 82 but also accuracies of depths and angles of countersinks 81A and 82A satisfy criteria.

In a case where the workpiece 8 is a member configuring an airframe of an aircraft, required machining accuracy including the depths and the angles of the countersinks are particularly high. The depths and the angles of the countersinks 81A and 82A influence on protrusion amounts of the rivets 85 from a surface of the workpiece 8, which may cause a gap with a member attached to the workpiece 8.

The present embodiment provides the drilling and countersinking tool 1 that can secure accuracy required for machining applied to a member of an aircraft.

### [Driving Mechanism]

As for the driving mechanism D housed in the housing 4, only the outline is described, and a specific illustration is omitted.

The driving mechanism D includes an air motor operated by compressed air supplied from the unillustrated compressed-air supply source, and a gear train transmitting rotational driving force generated by the air motor to the drills 2. The air motor is operated by the compressed air supplied through the supply portion 4C in response to operation of the trigger 4B.

### [Drill]

The paired drills 2 extend forward in parallel with each other from an upper part of the housing 4. In the present specification, a direction in which the paired drills 2 are arranged side by side is referred to as a right-left direction (x direction).

Further, in the present specification, an axial direction of each of the drills 2 is referred to as a front-rear direction (z direction). In this case, a front end side of each of the drills 2 is referred to as “front”, and a base end side of each of the drills 2 is referred to as “rear”.

Further, in an up-down direction (y direction), an upper side on a paper surface of FIG. 1 is referred to as “up”, and a lower side is referred to as “down” based on the up-down direction of the paper surface.

As illustrated in FIG. 2, each of the drills 2 includes a shaft 21 driven around an axis, and a drill main body 22 supported by the shaft 21. A blade 22A for drilling and a blade 22B for countersinking are provided at a front end side of the drill main body 22.

A stroke St of each of the drills 2 in the front-rear direction from a position St1 at start of machining to a position St2 at end of the machining is adjustable by a corresponding adjustment knob 23 (FIG. 1).

### [Feeding Mechanism]

The feeding mechanism 3 (FIG. 1 and FIG. 2) includes a head 10 that can guide the drills 2 and hold (clamp) the workpiece 8, an air cylinder 31 that serves as a linear motion mechanism relatively feeding the head 10 to the drills 2 with the stroke St, an oil damper 32 that can adjust a feeding speed, and a stopper 50 that regulates displacement of the head 10 at the terminal end St2 of the stroke St.

The tool 1 includes the stopper 50 regulating displacement of the head 10 especially to secure machining accuracy of countersinking. The tool 1 further includes a holding mechanism 40 easily attachable to and detachable from the head 10.

Each of the stopper 50, the head 10, and members provided in the head 10 can be formed by using an appropriate metal material.

The air cylinder 31 operates by the compressed air supplied through the supply portion 4C.

A piston rod 31A (FIG. 1 and FIG. 2) of the air cylinder 31 advances and retreats in the z direction relative to a front end 4D of the housing 4. An unillustrated another piston rod to move a moving member 45 (collet clamp finger) is incorporated in the piston rod 31A.

The air cylinder 31 relatively feeds the head 10 coupled to the piston rod 31A relative to the drills 2 with the stroke St along with progress of the machining by the drills 2. At this time, the feeding speed is adjusted by the oil damper 32 coupled to the piston rod 31A through an arm 33.

Drilling and countersinking can be performed in such a manner that the drills 2 are retreated by a holding stroke (not illustrated) from standby positions illustrated in an upper part of FIG. 2 by timely drawing the piston rod 31A into the cylinder, to hold the workpiece 8 to the head 10, and the head 10 and the workpiece 8 are then retreated relative to the drills 2 by the stroke St.

### (Head)

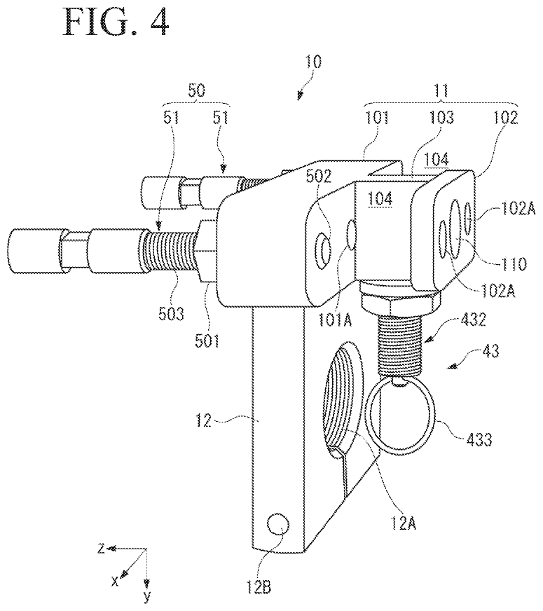

As illustrated in FIG. 2 and FIG. 4, the head 10 includes a guide portion 11 guiding the paired drills 2, the holding mechanism 40 holding the workpiece 8 by guide bushes 101A of the guide portion 11, and an engagement portion 12 including a female screw 12A engaging with the piston rod 31A.

The head 10 is fixed to the piston rod 31A by the female screw 12A and an unillustrated screw inserted into a through hole 12B of the engagement portion 12. The head 10 has a symmetrical shape with an axis of the piston rod 31A as a center.

A head of an existing drilling and countersinking tool also includes a guide portion and an engagement portion similar to the guide portion 11 and the engagement portion 12, and a mechanism that is provided in the guide portion to hold the workpiece 8. The head of such an existing tool can be replaced with the head 10 including the stopper 50 and the holding mechanism 40 as illustrated in FIG. 4.

The guide portion 11 includes a guide main body 101 guiding a base end side of each of the drill main bodies 22, an insertion portion 102 into which a front end side of each of the drill main bodies 22 is inserted, and a coupling portion 103 coupling the guide main body 101 and the insertion portion 102 at a center in a width direction (x direction) of the guide portion 11.

All of the guide main body 101, the insertion portion 102, and the engagement portion 12 are disposed in an attitude orthogonal to the axis of the air cylinder 31.

Gaps 104 are provided between the guide main body 101 and the insertion portion 102 so as to be symmetrical with the coupling portion 103 as a center. The drill main bodies 22 are disposed in the respective gaps 104.

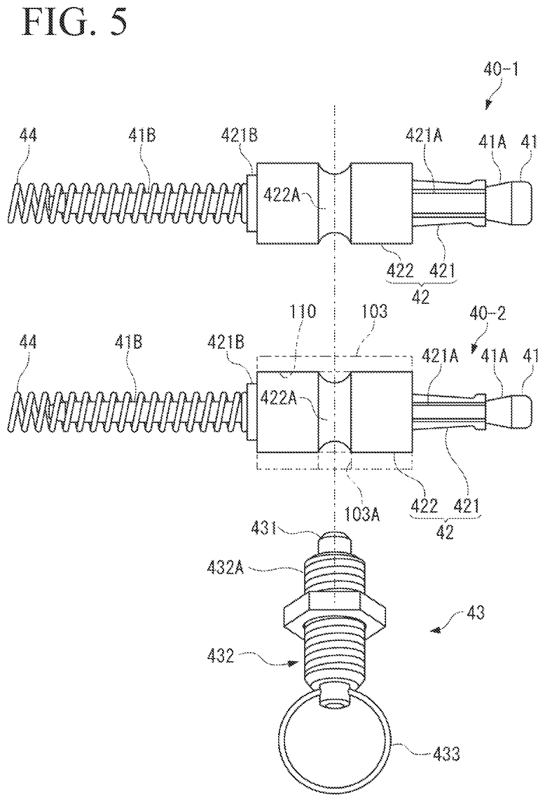

The guide portion 11 includes an insertion hole 110 that penetrates through the guide main body 101, the coupling portion 103, and the insertion portion 102 in the front-rear direction (z direction) at a center in the width direction (x direction) of the guide portion 11. A holding assembly 40-1 (FIG. 5) of the holding mechanism 40 is inserted into the insertion hole 110. The insertion hole 110 corresponds to a position of the holding hole 80 of the workpiece 8. A diameter of the insertion hole 110 corresponds to an outer diameter of a collet bushing 422 of the holding mechanism 40.

The guide main body 101 includes the paired guide bushes 101A penetrating through the guide main body 101 in the front-rear direction. The guide bushes 101A are disposed on both sides of the insertion hole 110 in the right-left direction.

The insertion portion 102 includes paired insertion holes 102A into which the respective drill main bodies 22 are inserted. The drill main bodies 22 are inserted into the respective guide bushes 101A and the respective insertion holes 102A in the same linear line.

Before machining by the drills 2 is started, front ends 22T of the paired drill main bodies 22 are positioned in the respective gaps 104 as illustrated in the upper part of FIG. 2. Thereafter, as illustrated in a lower part of FIG. 2, while the machining is performed on the workpiece 8 held by the head 10, the drill main bodies 22 advancing toward the workpiece 8 are guided in a hole axis direction (z direction) by the respective guide bushes 101A.

The coupling portion 103 includes a locking hole 103A (FIG. 5) that extends in a direction orthogonal to the insertion hole 110 and communicates with the insertion hole 110. The collet bushing 422 inserted into the insertion hole 110 is locked to the head 10 by a locking portion 43 (FIG. 4 and FIG. 5) of the holding mechanism 40 through the locking hole 103A.

The locking hole 103A is preferably provided in a lower part of the coupling portion 103 such that the locking portion 43 protruding from the coupling portion 103 does not influence on workability in machining; however, the locking hole 103A may be provided in an upper part of the coupling portion 103.

### (Holding Mechanism)

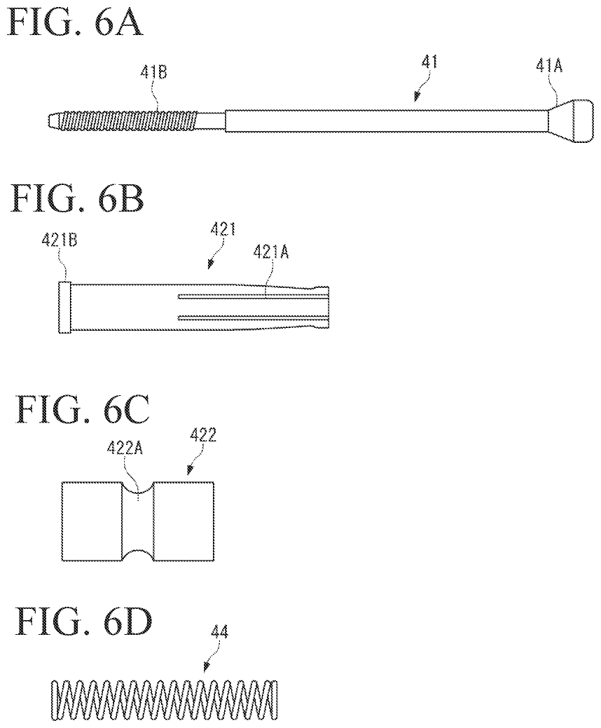

As illustrated in FIG. 5 and FIG. 6, the holding mechanism 40 includes a rod-shaped mandrel 41, a cylindrical collet element 42 externally inserted into the mandrel 41, the locking portion 43 locking the collet element 42 to the head 10, and a coil spring 44 (compression coil spring).

A set of the mandrel 41, the collet element 42, and the coil spring 44 is referred to as the holding assembly 40-1.

The collet element 42 includes a collet 421 and a collet bushing 422 externally inserted into the collet 421. A front area of the collet 421 is divided into a plurality of elastic pieces in a circumferential direction by a plurality of slits 421A extending in the front-rear direction.

FIG. 5 illustrates two holding assemblies 40-1 and 40-2 different in diameter at a front end of each of the mandrel 41 and the collet 421. The diameters of the mandrels 41 of the holding assemblies 40-1 and 40-2 are different from each other, and the diameters of the collets 421 of the holding assemblies 40-1 and 40-2 are also different from each other. Outer diameters of the collet bushings 422 of the holding assemblies 40-1 and 40-2 are equal to each other. Parts of the coil spring 44 and the locking portion 43 can be made common.

Out of the holding assemblies 40-1 and 40-2, one holding assembly including the mandrel 41 and the collet 421 suitable for the diameter of the holding hole 80 of the workpiece 8 can be selected and attached to the head 10. In addition to the holding assemblies 40-1 and 40-2, a plurality of holding assemblies suitable for various diameters of the holding hole 80 are preferably prepared because the same tool 1 can be applied to the workpiece 8 having the holding hole 80 of various diameters by changing the holding assembly.

After the front ends of the mandrel 41 and the collet 421 are inserted into the holding hole 80, the mandrel 41 is retreated with a predetermined holding stroke by being drawn by the unillustrated inner rod of the piston rod 31A having a double structure, through the moving member 45. At this time, a tapered portion 41A provided at the front end of the mandrel 41 is pressed against the front end of the collet 421 pressurized forward by the coil spring 44, and the workpiece 8 engaging with the front end of the mandrel 41 abuts on the insertion portion 102 of the head 10. As a result, the front end of the collet 421 is forcibly expanded from inside by the mandrel 41 to increase the diameter, and the workpiece 8 is accordingly restrained at a position of the holding hole 80.

The workpiece 8 is held along a surface of the insertion portion 102, by the mandrel 41 and the collet element 42 positioned between the paired drills 2. In a state where the workpiece 8 is held by the head 10, the head 10 and the workpiece 8 are retreated by the air cylinder 31 while the driving mechanism D rotates the drills 2. As a result, in a state where the workpiece 8 and the drills 2 are positioned, the drilling and the countersinking can be performed on the workpiece 8 while the drills 2 are advanced toward the workpiece 8.

When the trigger 4B is pressed, a series of operation from holding of the workpiece 8 with respect to the head 10 to the drilling and the countersinking by the drills 2 guided by the head 10 is sequentially performed.

A male screw 41B (FIG. 6) engaging with the moving member 45 (FIG. 1 and FIG. 2) movable in the front-rear direction is provided on a base end side of the mandrel 41.

The moving member 45 protrudes in a radial direction from the piston rod 31A, is coupled to the inner rod of the piston rod 31A, and moves in the front-rear direction in conjunction with movement of the inner rod. The moving member 45 moves rearward from a standby position illustrated in the upper part of FIG. 2, and then retreats with the head 10. An opening width of an outer rod of the piston rod 31A having the double structure from the standby position corresponds to a stroke of the moving member 45, and the stroke corresponds to the holding stroke to hold the workpiece 8 to the head 10.

The collet bushing 422 has a length shorter than a dimension of the head 10 in the front-rear direction, and is locked to an inside of the head 10 by the locking portion 43.

The collet bushing 422 includes a concave portion 422A having a width corresponding to a pin 431 of the locking portion 43. The concave portion 422A may be a groove or a hole. The concave portion 422A is not necessarily provided over an entire circumference of the collet bushing 422.

The collet 421 is externally inserted into the mandrel 41, and the collet bushing 422 is externally inserted into the collet 421. The coil spring 44 is disposed around the base end side of the mandrel 41 protruding rearward from the collet 421.

The mandrel 41, the collet element 42, and the coil spring 44 are inserted into the insertion hole 110 of the head 10, the male screw 41B of the mandrel 41 engages with the moving member 45, and the collet bushing 422 is locked to the head 10 by the locking portion 43. As a result, the holding mechanism 40 is assembled to the head 10. The coil spring 44 is held in a deflected state between a rear end 421B of the collet 421 and the moving member 45. The collet 421 drawn in holding of the workpiece 8 returns to an original position by elastic force of the coil spring 44.

The locking portion 43 (FIG. 4 and FIG. 5) locks the collet bushing 422 inserted into the insertion hole 110 of the head 10, to the head 10. The locking portion 43 includes the pin 431 insertable into and removable from the concave portion 422A provided in the collet bushing 422, through the locking hole 103A (opening) of the coupling portion 103.

As the locking portion 43, what is called an index plunger is preferably adopted. In FIG. 4 and FIG. 5, an example of the locking portion 43 as the index plunger is illustrated. The locking portion 43 includes, in addition to the pin 431, a casing 432, an unillustrated spring that is housed with the pin 431 in the casing 432 and pressurizes the pin 431, and a ring-shaped knob 433 to pull the pin 431 against elastic force of the spring.

When the male screw 432A engages with the female screw of the locking hole 103A, the locking portion 43 is attached to the coupling portion 103.

When a front end of the pin 431 is inserted into the concave portion 422A of the collet bushing 422 through the locking hole 103A, the collet bushing 422 is locked to the head 10 in a state where movement of the collet bushing 422 in the front-rear direction is regulated. The pin 431 is held to the concave portion 422A by the elastic force of the spring.

### (Assembly of Holding Mechanism)

Using the locking portion 43 makes it possible to easily and rapidly perform a work to assemble the holding assembly 40-1 or 40-2 (a set of mandrel 41, collet element 42, and coil spring 44) to the head 10, and a work to disassemble the holding assembly from the head 10.

An example of a working procedure is described below.

To disassemble the holding assembly 40-1 from the head 10, the mandrel 41 is rotated around the axis to detach the male screw 41B from the moving member 45, and the pin 431 is pulled by the knob 433 until the front end of the pin 431 is separated from the concave portion 422A. As a result, the collet bushing 422 pushed by the elastic force of the coil spring 44 protrudes forward from the head 10. Therefore, the holding assembly 40-1 can be pull out from the insertion hole 110 of the head 10 and can be inspected and replaced.

To assemble the holding assembly 40-2 to the head 10 in place of the pulled-out holding assembly 40-1, the holding assembly 40-2 is inserted into the insertion hole 110 while the pin 431 is pulled by the knob 433. Subsequently, the collet bushing 422 is housed in the insertion hole 110 by being pushed from forward the head 10, and the male screw 41B of the mandrel 41 engages with the moving member 45. As a result, assembly of the holding assembly 402 to the head 10 ends.

Assembly/disassembly of the holding assembly 40-1 or 40-2 to/from the head 10 can be performed without using a working tool such as a fastening tool.

In addition, it is unnecessary to disassemble the head 10 and the members assembled to the head 10, such as the piston rod 31A. Disassembly and reassembly of the members, and positional adjustment of the members along therewith are unnecessary. This makes it possible to easily and rapidly replace the holding assemblies 40-1 and 40-2.

In a case where the locking portion 43 is not provided in the head 10, and disassembly and reassembly of the head 10 and the like are necessary due to, for example, screwing of the collet bushing 422 to the head 10, replacement of the holding assemblies 40-1 and 40-2 is hardly performed because of a complicated work. The drilling and countersinking tool in this case is applicable only to the workpiece 8 including the holding hole 80 corresponding to the diameter of the attached mandrel 41 and the diameter of the attached collet element 42.

In contrast, according to the present embodiment, replacement of the holding assembly enables the same tool 1 to be generally used for machining of various workpieces 8 different in diameter of the holding hole 80. This makes it possible to contribute to reduction of a procurement cost of the tool 1.

### (Stopper)

The stopper 50 (FIG. 2 and FIG. 4) regulates displacement of the head 10 guiding the drills 2 in the machining by abutting on a reception portion at the terminal end St2 of the stroke St (hereinafter, stroke terminal end St2).

The stopper 50 according to the present embodiment is integrated with the head 10, and is driven with the head 10 in the front-rear direction by the air cylinder 31. The reception portion on which the stopper 50 according to the present embodiment abuts at the stroke terminal end St2 corresponding to a final stage of the machining from the drilling to the countersinking, corresponds to a flat portion of the front end 4D of the housing 4 positioned more rearward than the position of the guide portion 11 of the head 10.

The head 10 retreating while being supported by the piston rod 31A is supported by, in addition to the piston rod 31A, the stopper 50 abutting on the front end 4D of the housing 4, at the stroke terminal end St2. As a result, even when the head 10 is inclined to the workpiece 8 due to backlash (fitting tolerance or allowance) of the piston rod 31A before the stroke terminal end St2, namely, when the stopper 50 is separated from the front end 4D, the backlash is limited by increase of the number of supporting points of the head 10 at the end of machining. This regulates inclination of the head 10.

Since inclination and sinking of the head 10 to the workpiece 8 are regulated at the end of machining, the positions of the drills 2 that are inserted into the guide bushes 101A and the insertion holes 102A and countersink the workpiece 8, can be fixed. This makes it possible to suppress variation of the depths and the angles of the countersinks machined in the workpiece 8, and to secure machining accuracy required for the countersinking.

Since the stopper 50 is separated from the front end 4D in the drilling, the stopper 50 does not influence on accuracy of dimensional shapes of the holes formed in the workpiece 8.

Unlike the countersinking, the drilling is performed in such a manner that the drills 2 cuts the workpiece 8 so as to penetrate through the workpiece 8. Therefore, even if the drills 2 are inclined to the workpiece 8 due to the inclination of the head 10 caused by the backlash in the machining, it is possible to sufficiently secure the machining accuracy required for the drilling.

The stopper 50 preferably includes one or more supporting portions 51 protruding from the head 10 toward the front end 4D of the housing 4.

The stopper 50 according to the present embodiment includes paired rod-shaped supporting portions 51 each extending rearward from the guide main body 101 by a predetermined length. The paired supporting portions 51 are fastened to the guide main body 101 by nuts 501 and screws 502 on the position more outside than that of the paired guide bushes 101A into which the drills 2 are inserted, in the right-left direction (x direction).

Front ends 51A of the respective supporting portions 51 abut on the front end 4D of the housing 4 at the same time or at the substantially same time. In this case, at the stroke terminal end St2, the head 10 is stably supported by the paired supporting portions 51 and the piston rod 31A coupled to the engagement portion 12 at three points in total. This makes it possible to more sufficiently regulate displacement of the head 10.

Each of the supporting portions 51 has a length corresponding to a length of the stroke St so as to abut on the front end 4D at the stroke terminal end St2. When distances from the front ends 51A of the respective supporting portions 51 to the front end 4D are equal to each other, the supporting portions 51 can be set to the same length.

To deal with individual difference of the stroke St of the tool 1, the lengths of the supporting portions 51 can be adjusted to the lengths suitable for the prescribed stroke St by rotating the screws 502 engaging with the respective nuts 501 around the axes to change protrusion amounts of the screws 502 from the respective nuts 501.

If the lengths of the supporting portions 51 cannot be adjusted, the supporting portions 51 are detachably fastened to the head 10. Therefore, the supporting portions 51 can be replaced with the supporting portions 51 having different lengths.

To sufficiently regulate the inclination of the head 10, a distance from the position of the piston rod 31A to each of the supporting portions 51 in the x direction and the y direction is preferably large rather than small. In addition, in a case where the stopper 50 includes the plurality of supporting portions 51, the supporting portions 51 are preferably disposed symmetrically with the axis of the piston rod 31A.

In the present embodiment, the paired supporting portions 51 are disposed symmetrically with the center of the guide main body 101 in the right-left direction on the position more outside than that of the paired guide bushes 101A into which the drills 2 are inserted, in the right-left direction (x direction). According to the present embodiment, the head 10 is supported by the piston rod 31A and the paired supporting portions 51 at two or more points at the stroke terminal end St2 in both of the right-left direction (x direction) and the up-down direction (y direction). Therefore, it is possible to sufficiently secure the machining accuracy of the countersinking.

According to the tool 1 of the present embodiment described above, not only the machining accuracy of the drilling but also the machining accuracy of the countersinking are secured by the stopper 50. Therefore, it is possible to sequentially perform the drilling and the countersinking at a time only by using the tool 1 without changing the tool 1 to another countersinking tool after drilling of the tool 1. This makes it possible to considerably shorten the machining time and to improve productivity, as compared with a case where the drilling step and the countersinking step are divided due to change of the tool.

In addition, since the holding mechanism 40 provided in the tool 1 enables easy and rapid replacement to the holding assembly 40-1 or 40-2 suitable for the holding hole 80 of the workpiece 8, it is possible to improve workability of the drilling and the countersinking for various kinds of workpieces.

### Second Embodiment

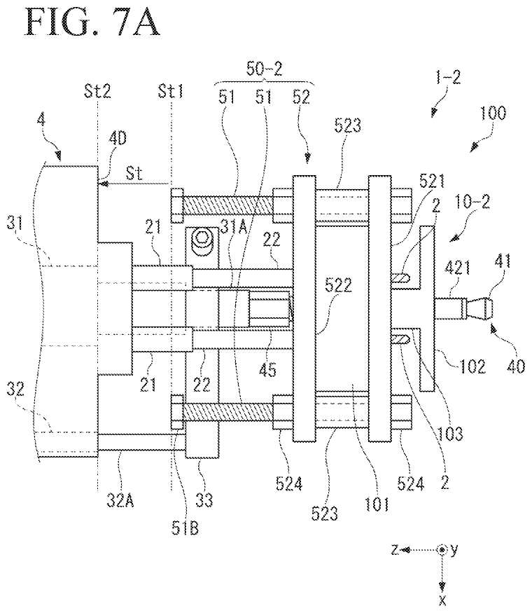

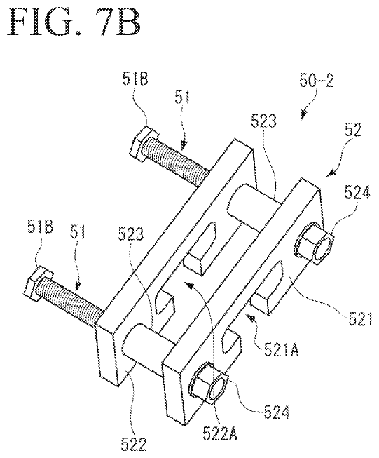

Next, a second embodiment of the present disclosure is described with reference to FIG. 7A and FIG. 7B.

In the following, matters different from the first embodiment are mainly described.

A tool 1-2 according to the second embodiment has a configuration similar to the configuration of the tool 1 according to the first embodiment mainly except for forms of a head 10-2 and a stopper 50-2.

The stopper 50-2 can be attached to the head 10-2 so as to sandwich the guide main body 101 of the head 10-2 from both sides in the front-rear direction (z direction).

Therefore, holes to which the stopper 50-2 is attached, and the like are not machined in the head 10-2.

The head 10-2 does not include the locking portion 43 or the locking hole 103A. The collet bushing 422 according to the present embodiment externally inserted into the mandrel 41 and the collet 421 may be locked to the head 10-2 by, for example, engagement of the male screw on the outer periphery with the female screw of the insertion hole 110.

The head 10-2 corresponds to a form of the head of the existing drilling and countersinking tool. In other words, the drilling and the countersinking can be performed at a time while securing machining accuracy of the drilling and the countersinking, only by the tool 1-2 in which the stopper 50-2 as the auxiliary tool is attached to the head 10-2, by attaching the stopper 50-2 to the guide portion of the head of the existing tool.

The application is not limited to the existing tool, and it is possible to provide a new tool 1-2 including a tool main body 100 that includes the drills 2, the driving mechanism D driving the drills 2, the head 10-2, the air cylinder 31, and the like, and the stopper 50-2 detachably provided to the tool main body 100.

The stopper 50-2 includes an attachment portion 52 attachable to the guide main body 101, and one or more supporting portions 51 provided in the attachment portion 52 and extending toward the reception portion (front end 4D of housing 4) along the z direction in which the head 10-2 moves.

Lengths of the supporting portions 51 can be adjusted by advancing and retreating bolt heads 51B of the supporting portions 51 relative to respective nuts 524.

FIG. 7B illustrates a single stopper 50-2.

The attachment portion 52 includes a front plate 521 disposed on a front side of the guide main body 101, and a rear plate 522 disposed on a rear side of the guide main body 101.

The front plate 521 and the rear plate 522 respectively include openings 521A and 522A into which the paired drill main bodies 22, the mandrel 41, the collet element 42, the coil spring 44, and the moving member 45 are insertable.

On a right side and a left side of the guide main body 101, spacers 523 are disposed coaxially with the supporting portions 51 between the front plate 521 and the rear plate 522.

The stopper 50-2 can be attached to the head 10-2 in such a manner that the guide main body 101 is housed between the front plate 521 and the rear plate 522 from above, and the nuts 524 are fastened from both sides in the front-rear direction while sandwiching spacers 523. To detach the stopper 50-2 from the head 10-2, the nuts 524 may be removed to separate the front plate 521 and the rear plate 522 from the head 10-2. Both of attachment and detachment of the stopper 50-2 can be easily performed without performing disassembly and reassembly of the head 10-2 and the like.

The stopper 50-2 can be easily attached to the head 10-2 of the existing tool without requiring machining of the holes and the like for attachment of the stopper 50-2 to the head 10-2 of the existing tool. Therefore, the stopper 50-2 is useful as the auxiliary tool added to the head 10-2 of the existing tool without being limited to assembly to the tool 1-2 newly provided.

Also in the second embodiment, the locking hole 103A may be machined in the head 10-2 and the holding assembly 40-1 or 40-2 may be locked to the head 10-2 by the locking portion 43, as in the first embodiment. In other words, the holding mechanism 40 is optionally adoptable. This is true of a third embodiment and a fourth embodiment.

### Third Embodiment

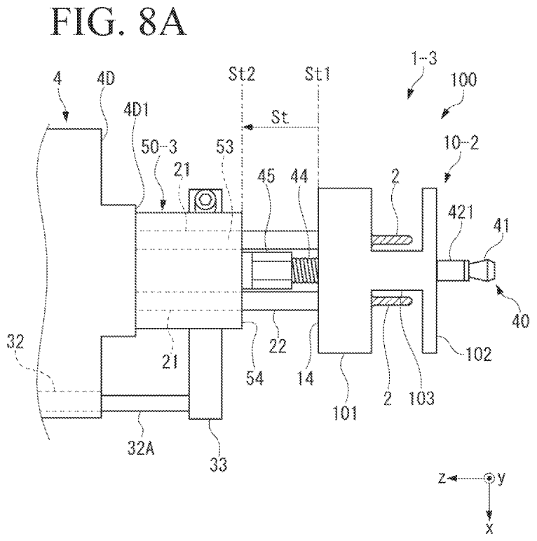

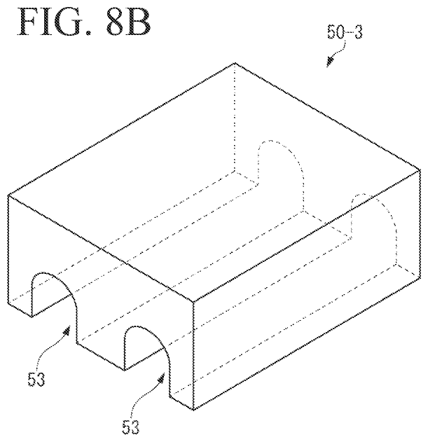

Next, the third embodiment of the present disclosure is described with reference to FIG. 8A and FIG. 8B.

A tool 1-3 according to the third embodiment has a configuration similar to the configuration of the tool 1-2 according to the second embodiment except for a form of a stopper 50-3.

In the following, matters different from the second embodiment are mainly described.

As illustrated in FIG. 8B, the stopper 50-3 has an outer shape formed in a substantially rectangular parallelepiped block shape. The stopper 50-3 includes paired parallel grooves 53 recessed from one surface. The drills 2 are inserted into the respective grooves 53. The stopper 50-3 is fastened to the housing 4 by bolts through, for example, holes opened from a front end 54 toward the front end 4D of the housing 4.

In the present embodiment, a distance between the front end 54 of the stopper 50-3 disposed in a convex portion 4D1 of the front end 4D of the housing 4 and a rear end 14 of the head 10-2 corresponds to the stroke St. Further, the reception portion on which the stopper 50-3 abuts corresponds to the guide main body 101 of the head 10-2.

When the front end 54 of the stopper 50-3 abuts on the rear end 14 of the head 10-2 at the stroke terminal end St2, displacement of the head 10-2 is regulated. Therefore, it is possible to perform the drilling and the countersinking at a time while securing machining accuracy of the drilling and the countersinking by the tool 1-3.

The stopper 50-3 according to the third embodiment is similar to the stopper 50 and the stopper 50-2 in that the stopper 50-3 is easily attachable to and detachable from the tool main body 100 without performing disassembly and reassembly of the head 10-2 and the like, even though the shape of the stopper 50-3 is different from the shapes of the stopper 50 according to the first embodiment and the stopper 50-2 according to the second embodiment. In particular, the stopper 50-3 is similar to the stopper 50-2 in that the stopper 50-3 is useful as the auxiliary tool added to the head 10-2 of the existing tool.

### Fourth Embodiment

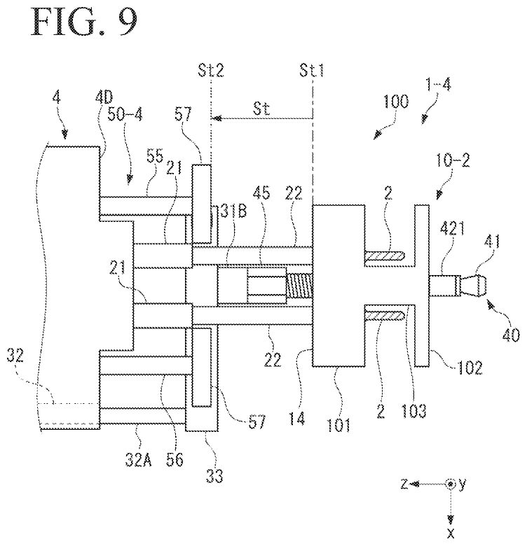

Next, the fourth embodiment of the present disclosure is described with reference to FIG. 9.

As illustrated in FIG. 9, a stopper 50-4 may be provided in the housing 4. The stopper 50-4 includes paired supports 55 and 56 installed in the front end 4D of the housing 4, and a plate 57 supported by front ends of the supports 55 and 56.

In the present embodiment, a distance between the plate 57 and the rear end 14 of the head 10-2 corresponds to the stroke St. The reception portion on which the stopper 50-4 abuts corresponds to the guide main body 101 of the head 10-2.

When the plate 57 abuts on the rear end 14 of the head 10-2 at the stroke terminal end St2, displacement of the head 10-2 is regulated. Therefore, it is possible to perform the drilling and the countersinking at a time while securing machining accuracy of the drilling and the countersinking.

The stopper 50-4 is preferably provided so as to be attachable to and detachable from the tool main body 100 of a tool 1-4 without performing disassembly and reassembly of the head 10-2 and the like. When the stopper 50-4 is attachable to and detachable from the tool main body 100, the stopper 50-4 is also useful as the auxiliary tool added to the head 10-2 of the existing tool.

The above-described first embodiment (or second embodiment) and the fourth embodiment may be combined to make a configuration in which the supporting portions 51 of the stopper 50 (FIG. 2) abut on the plate 57. Lengths of the supporting portions 51 and the supports 55 and 56 are adjusted based on the stroke St.

In this case, a counter reception portion of the supporting portions 51 of the stopper 50 corresponds to the plate 57, and a counter reception portion of the plate 57 of the stopper 50-4 corresponds to the supporting portions 51.

In other words, a stopper configuration including the stopper 50 provided in the head 10 and the stopper 50-4 provided in the housing 4 can be adopted.

Other than the above description, the configurations described in the above-described embodiments can be selected and appropriately alternated.

The stopper according to the present disclosure can be provided in an appropriate member such as the air cylinder, in addition to the head 10, the drills 2, and the housing 4.

The tool according to the present disclosure does not necessarily include the paired drills 2 as long as the tool includes one or more drills 2. For example, in a case where the drilling and the countersinking of a single hole 81 are performed, a drilling and countersinking tool including the single drill 2, the driving mechanism D driving the drill 2, the feeding mechanism 3, and the stopper 50 can be adopted. The tool preferably includes the holding mechanism 40 because the tool can deal with a plurality of types of diameters of the holding hole 80 of the workpiece 8 as described above.

### [Supplement]

The drilling and countersinking tool and the drilling and countersinking auxiliary tool described above disclose the following supplements.
(1) The tool 1 including the drills 2 usable for drilling and countersinking, includes: the head 10 configured to guide the drills 2 and to hold the workpiece 8; the linear motion mechanism (31) configured to relatively move the head 10 relative to the drills 2 with the predetermined stroke St along with progress of machining by the drills 2; and the stopper 50 configured to regulate displacement of the head 10 guiding the drills 2 in the machining by abutting on the reception portion (4D) at the terminal end St2 of the stroke St.
(2) The length of the stopper 50 in the moving direction (z direction) of the head 10 is adjustable.
(3) The stopper 50 is provided in at least one of the head 10 and the housing 4 of the driving mechanism D driving the drills 2.
(4) The stopper 50 includes one or more supporting portions 51 abutting on the reception portion (4D).
(5) The stopper 50 is detachably provided in the tool main body 100 that includes the drills 2, the driving mechanism D driving the drills 2, the head 10, and the linear motion mechanism (31).
(6) The head 10 includes the mandrel 41 inserted into the holding hole 80 provided in the workpiece 8, the collet element 42 externally inserted into the mandrel 41 and inserted into the insertion hole 110 provided in the head 10, and the locking portion 43 locking the collet element 42 to the head 10, and the locking portion 43 includes the pin 431 insertable into and removable from the concave portion 422A provided in the collet element 42 inserted into the insertion hole 110, through the opening (103A) of the head 10.
(7) The workpiece 8 corresponds to a member configuring an airframe of an aircraft.
(8) When the drilling and countersinking tool 1, 1-2, 1-3, or 1-4 includes the head 10 or 10-2 configured to guide drills 2 usable for drilling and countersinking and to hold a workpiece, and the linear motion mechanism (31) configured to relatively move the head 10 or 10-2 relative to the drills 2 with the predetermined stroke St along with progress of machining by the drills 2, the stopper (50, 50-2, 50-3, or 50-4) as the auxiliary tool attachable to the tool 1 corresponds to a stopper configured to regulate displacement of the head 10 or 10-2 guiding the drills 2 in the machining by abutting on the reception portion (4D, 101) at the terminal end St2 of the stroke St.
(9) The length of the stopper 50 or 50-2 as the auxiliary tool in the moving direction of the head 10 or 10-2 is adjustable.
(10) One or more supporting portions 51 (55, 56) abutting on the reception portion (4D, 101) at the terminal end St2 of the stroke St are provided.
(11) The stopper 50-2 as the auxiliary tool includes the attachment portion 52 attachable to the head 10-2, and one or more supporting portions 51 provided in the attachment portion 52 and extending toward the reception portion (4D).

### REFERENCE SIGNS LIST 1, 1-2, 1-3, 1-4 Drilling and countersinking tool

2 Drill
3 Feeding mechanism
4 Housing
4A Grip portion
4B Trigger
4C Supply portion
4D Front end
4D1 Convex portion
8 Workpiece
10, 10-2 Head
11 Guide portion
12 Engagement portion
12A Female screw
12B Through hole
14 Rear end
21 Shaft
22 Drill main body
22A Blade
22B Blade
22T Front end
23 Adjustment knob
31 Air cylinder (linear motion mechanism)
31A Piston rod
32 Oil damper
33 Arm
40 Holding mechanism
40-1, 40-2 Holding assembly
41 Mandrel
41A Tapered portion
41B Male screw
42 Collet element
43 Locking portion
44 Coil spring
45 Moving member
50, 50-2, 50-3, 50-4 Stopper (auxiliary tool)
51 Supporting portion
51A Front end
51B Bolt head
52 Attachment portion
53 Groove
54 Front end
55, 56 Support (supporting portion)
57 Plate
80 Holding hole
81, 82 Hole
81A, 82A Countersink
84 Nut plate
85 Rivet
91 Piston rod
92 Head
93 Drill
100 Tool main body
101 Guide main body
101A Guide bush
102 Insertion portion
102A Insertion hole
103 Coupling portion
103A Locking hole (opening)
104 Gap
110 Insertion hole
421 Collet
421A Slit
421B Rear end
422 Collet bushing
422A Concave portion
431 Pin
432 Casing
432A Male screw
433 Knob
501 Nut
502 Screw
521 Front plate
522 Rear plate
521A, 522A Opening
523 Spacer
524 Nut
D Driving mechanism
St Stroke
St1 Stroke starting end
St2 Stroke terminal end

What is claimed is:

1. A drilling and countersinking tool including drills usable for drilling and countersinking, the tool comprising:
a head configured to guide the drills and to hold a workpiece;
a linear motion mechanism configured to relatively move the head relative to the drills with a predetermined stroke along with progress of machining by the drills; and
a stopper configured to regulate displacement of the head guiding the drills in the machining by abutting on a reception portion at a terminal end of the stroke.

2. The drilling and countersinking tool according to claim 1, wherein
a length of the stopper in a moving direction of the head is adjustable.

3. The drilling and countersinking tool according to claim 1, wherein
the stopper is provided in at least one of the head and a housing of a driving mechanism driving the drills.

4. The drilling and countersinking tool according to claim 3, wherein
the stopper includes one or more supporting portions abutting on the reception portion.

5. The drilling and countersinking tool according to claim 1, wherein
the stopper is detachably provided in a tool main body that includes the drills, a driving mechanism driving the drills, the head, and the linear motion mechanism.

6. The drilling and countersinking tool according to claim 1, wherein
the head includes a mandrel, a collet element, and a locking portion, the mandrel being inserted into a holding hole provided in the workpiece, the collet element being externally inserted into the mandrel and being inserted into an insertion hole provided in the head, the locking portion locking the collet element to the head, and
the locking portion includes a pin insertable into and removable from a concave portion provided in the collet element inserted into the insertion hole, through an opening of the head.

7. The drilling and countersinking tool according to claim 1, wherein
the workpiece corresponds to a member configuring an airframe of an aircraft.

8. A drilling and countersinking auxiliary tool attachable to a drilling and countersinking tool that includes a head and a linear motion mechanism,
the head being configured to guide drills usable for drilling and countersinking and to hold a workpiece,
the linear motion mechanism being configured to relatively move the head relative to the drills with a predetermined stroke along with progress of machining by the drills,
the auxiliary tool corresponding to a stopper configured to regulate displacement of the head guiding the drills in the machining by abutting on a reception portion at a terminal end of the stroke.

9. The drilling and countersinking auxiliary tool according to claim 8, wherein
a length of the auxiliary tool in a moving direction of the head is adjustable.

10. The drilling and countersinking auxiliary tool according to claim 8, further comprising
one or more supporting portions abutting on the reception portion at the terminal end of the stroke.

11. The drilling and countersinking auxiliary tool according to claim 10, further comprising:
an attachment portion attachable to the head; and
the one or more supporting portions provided in the attachment portion and extending toward the reception portion.

12. The drilling and countersinking tool according to claim 6, wherein
the workpiece corresponds to a member configuring an airframe of an aircraft.

13. The drilling and countersinking auxiliary tool according to claim 10, wherein
the workpiece corresponds to a member configuring an airframe of an aircraft.
